(19) United States
(12) Patent Application Publication
(10) Pub. No.: US 2006/0123168 A1
(43) Pub. Date: Jun. 8, 2006

(54) SYSTEM AND METHOD FOR DYNAMICALLY ALLOCATING ADDRESSES TO DEVICES COUPLED TO AN INTEGRATED CIRCUIT BUS

(76) Inventor: Yu-Ming Lang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,280

(22) Filed: Nov. 17, 2005

(30) Foreign Application Priority Data
Dec. 3, 2004 (TW) 093137387

(51) Int. Cl. G06F 13/00

(52) U.S. Cl. 710/110

(57) ABSTRACT

The present invention provides a system for dynamically allocating addresses to devices (110, 120, 130) coupled to an integrated circuit bus (102). The system includes a master processor (101) and a plurality of slave processors (111, 121, 131) corresponding to the devices. The master processor is used for generating a plurality of addresses one by one which are different from each other, and sending an instruction to the integrated circuit bus in order to assign one of the plurality of addresses to one of the devices whose address is a default address at that time. Each of the plurality of slave processors includes a plurality of functions of: presetting an address of a corresponding device of the devices to the default address, retrieving the instruction and resetting the address of the corresponding device of the devices according to the instruction.

### FIELD OF THE INVENTION

The present invention is generally related to systems and methods for allocating addresses to devices coupled to an integrated circuit bus, and, more particularly, to a system and method for dynamically allocating addresses to devices coupled to an inter integrated circuit (I²C) bus.

### DESCRIPTION OF RELATED ART

The Philips Inter Integrated Circuit (I²C) bus is a bi-directional two-wire serial bus, which has been applied broadly because of its low implementing cost and great performance.

Devices coupled to the I²C bus should be assigned to different addresses in order that the devices can be identified and accessed. Normally, the addresses of devices coupled to the I²C bus are predetermined by hardwiring on circuit boards. Thus, there is a limitation of the I²C bus that it will only allow a single device to respond to each even address between 00 and FF. In this regard, most I²C devices must have a predetermined address, which is typically assigned with the use of strapping pins on the device. For example, if an I²C device has three strapping pins, which limit their addresses to A0-AF. That is, only 8 devices can be connected to an I²C bus.

Therefore, what is needed is a system and method for dynamically allocating addresses to devices coupled to an I²C bus by utilizing software, which overcomes the quantity limitation of devices coupled to the I²C bus.

### SUMMARY OF INVENTION

Embodiments of the present invention provide systems and methods for dynamically allocating addresses to devices coupled to an integrated circuit bus.

Briefly described, one embodiment of such a system among others, can be implemented as described herein. The system includes a first slave processor that presets an address of a first device of the devices coupled to the integrated circuit bus to a default address. The system also includes a master processor that assigns a first address to the first device whose address is the default address at that time, and a second slave processor that presets an address of a second device connected to the integrated circuit bus downstream of the first device to the default address after the first address is assigned to the first device. The master processor further assigns a second address to the second device whose address is the default address at that time. The second address is different from the first address.

Another embodiment of such a system among others, can be implemented as described herein. The system includes a master processor and a plurality of slave processors corresponding to the devices. The master processor is used for generating a plurality of addresses one by one which are different from each other, and sending an instruction to the integrated circuit bus in order to assign one of the plurality of addresses to one of the devices whose address is a default address at that time. Each of the plurality of slave processors includes a plurality of functions of: presetting an address of a corresponding device of the devices to the default address, retrieving the instruction and resetting the address of the corresponding device of the devices according to the instruction.

One embodiment of such a method, among others, can be broadly summarized by the steps described hereinafter. The method includes the steps of: controlling, by a first power supply, a voltage of a first device of the devices coupled to the integrated circuit bus, in order that an address can be set to the first device; presetting the address of the first device to a default address; assigning a first address to the first device; controlling, by a second power supply, a voltage of a second device of the devices coupled to the integrated circuit bus downstream of the first device, in order that an address can be set to the second device; presetting the address of the second device to the default address; and assigning a second address to the second device, the second address being different from the first address.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram illustrating a system for dynamically allocating addresses to devices coupled to an I²C bus, in accordance with one embodiment of the present invention;

FIG. 2 is a flowchart illustrating a method for dynamically allocating addresses to devices coupled to the I²C bus of FIG. 1 by utilizing slave processors of the devices, in accordance with one embodiment of the present invention; and

FIG. 3 is a flowchart illustrating a method for dynamically allocating addresses to the devices coupled to the I²C bus by utilizing a master processor of a bus driver, in accordance with one embodiment of the present invention.

### DETAILED DESCRIPTION

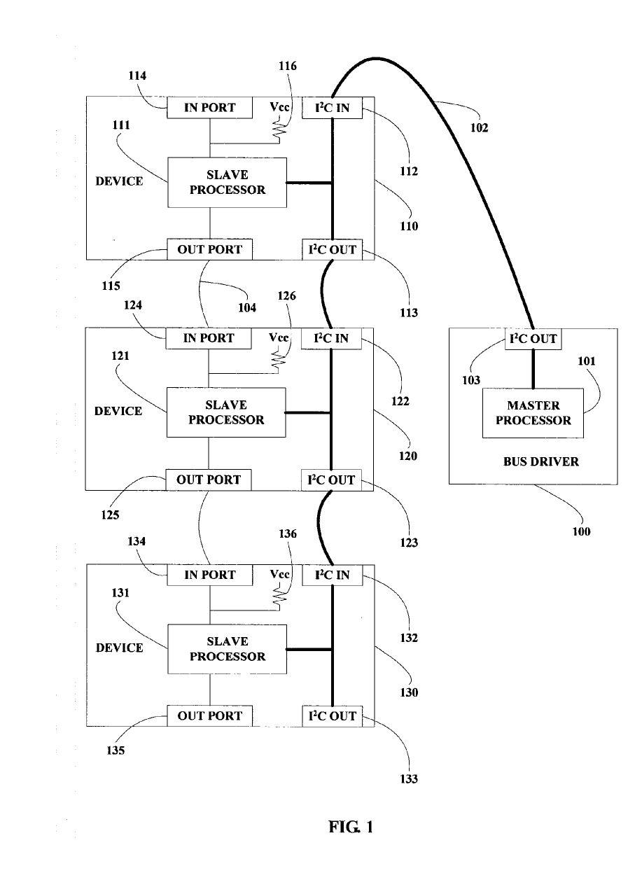

FIG. 1 is a schematic diagram illustrating a system for dynamically allocating addresses to devices coupled to an I²C bus (hereinafter, “the system”), in accordance with one embodiment of the present invention. The system may be a data processing system, such as a computer system, a network computer system, or even a personal digital assistant (PDA). The system employs an I²C bus architecture. The I²C bus 102 is a bi-directional serial integrated circuit bus requiring only two wires: a serial data line (SDL) and a serial clock line (SCL) (combined and represented by the thick line in FIG. 1). Each of a bus driver 100 and three devices (110, 120, 130) connected to the I²C bus 102 can operate either as a transmitter or a receiver. Each I²C bus compatible device has an on-chip interface which allows the device to communicate directly with the other devices via the I²C bus 102. The system has a simple slave/master relationship existing therein. A master is a device which initiates a data transfer and clock signals to permit the transfer. Any device addressed at the time of transfer is considered a slave. In the embodiment, the bus driver 100 acts as a master, while the devices (110, 120, 130) act as slaves. It should be noted that each of the devices (110, 120, 130) coupled to the I²C bus 102 is software addressable by a unique address. In this regard, there is no absolute quantity limitation of devices coupled to the I²C bus 102. In the embodiment, only three devices are coupled to the I²C bus 102.

The bus driver 100 includes a master processor 101, which assigns different addresses to all of the devices (110, 120, 130) in sequence. That is, the master processor 101 assigns an address to the device 110 firstly, then the device 120, and lastly the device 130, because the devices (110, 120, 130) are coupled to the I²C bus 102 serially in the sequence described above. In other words, the device 110 is downstream the I²C bus 102 of the bus driver 100, and the device 120 is downstream the I²C bus 102 of the device 110, and further more, the device 130 is downstream the I²C bus 102 of the device 120.

Additionally, an electrical bus 104 connects the devices (110, 120, 130) in series in the same sequence as the I²C bus 102 connects the devices (110, 120, 130). Each of the devices (110, 120, 130) has similar hardware configuration. Specifically, each of the devices (110, 120, 130) includes a slave processor (111, 121 or 131), an port I²C in (112, 122 or 132) and an port I²C out (113, 123 or 133), an electrical in port (114, 124 or 134) and an out port (115, 125 or 135), and a Vcc (116, 126 or 136) power supply for controlling voltages of the corresponding in port (114, 124 or 134) and the out port (115, 125 or 135).

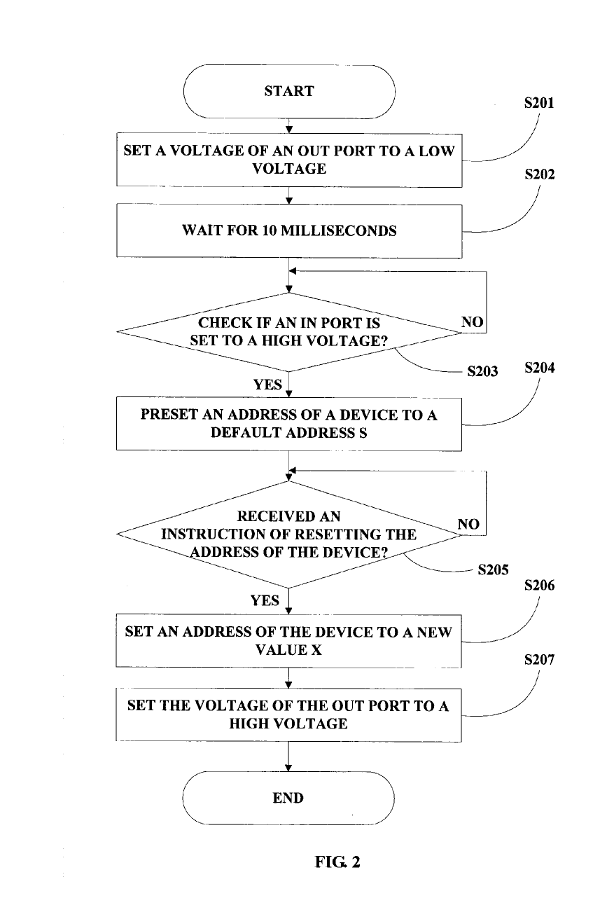

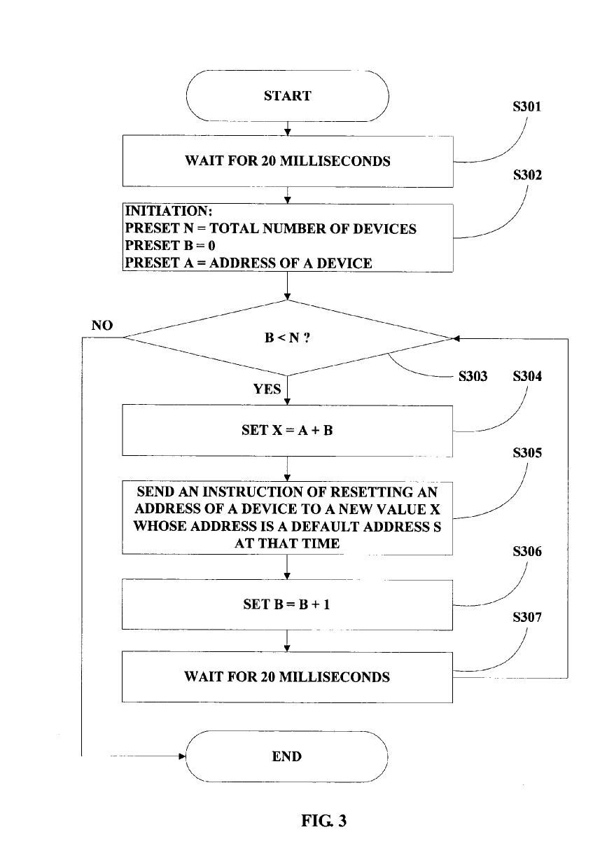

The preferred method implemented by the system is described step by step by incorporating FIG. 2 and FIG. 3. FIG. 2 is a flowchart illustrating a method for dynamically allocating addresses to the devices (110, 120, 130) coupled to the I²C bus 102 by utilizing the slave processors (111, 121, 131), and FIG. 3 is a flowchart illustrating a method for dynamically allocating addresses to the devices (110, 120, 130) coupled to the I²C bus 102 by utilizing the master processor 101 of the bus driver 100.

It should be noted that each of the devices (110, 120, 130) performs the procedures described in relation to FIG. 2 independently, and the bus driver 100 performs the procedures described in relation to FIG. 3.

Referring now to FIG. 2, in step S201, the slave processors (111, 121, 131) of the devices (110, 120, 130) firstly set voltages of the out ports (115, 125, 135) to a low voltage by using the Vcc (116, 126, 136) respectively. Specially for the device 110 rather than the devices 120 and 130, the Vcc 116 further sets a voltage of the in port 114 to a high voltage in order to initiate the procedure, because there is no device upstream the I²C bus 102 of the device 110. In step S202, the slave processors (111, 121, 131) of the devices (110, 120, 130) wait for a certain period, such as 10 milliseconds. It should be noted that each of the slave processors (111, 121, 131) of the devices (110, 120, 130) waits for the certain period, in order to make sure all the devices (110, 120, 130) perform step S201 in sequence described above. In step S203, each of the slave processors (111, 121, 131) of the devices (110, 120, 130) checks if the corresponding in port (114, 124 or 134) is set to a high voltage. Since the Vcc 116 has set the voltage of the in port 114 to a high voltage in step S201, for the device 110, the procedure goes directly to step S204. As for the devices 120 and 130, the slave processors 121 and 131 perform the checking process respectively until the voltage of the in port 124 or the in port 134 is set to a high voltage. In step S204, the slave processor 111 presets an address of the device 110 to a default address constant S, such as S=60h. In step S205, the slave processor 111 checks if an instruction of resetting the address of the device 110 has been received. The instruction is to reset a new address with a value of a variable X to the device, whose address is the default address S at the time. If such an instruction has been received, in step S206, the processor 111 sets the address of the device 110 with the value of the variable X according to the received instruction, such as X=10h.

In step S207, the device 110 sets a voltage of the out port 115 to a high voltage by using the Vcc 116, and the procedures performed by the device 110 ends here. It should be emphasized that the in port 124 has the same voltage as the out port 115 all the time, because the in port 124 of the device 120 is downstream the electrical bus 104 of the out port 115 of the device 110. That is, the in port 124 is now at a high voltage. Thus, the device 120 performs the procedures starting from step S203 described above, till the device 120 is assigned a new address, such as 11h, by the slave processor 121 in the similar way as the device 110. Finally, the device 130 is assigned a new address, such as 12h.

Referring now to FIG. 3, in step S301, the master processor 101 of the bus driver 100 waits for a certain period, such as 20 milliseconds, in order to make sure that the devices (110, 120, 130) have finished the steps S201 and S202. In step S302, the master processor 101 initiates its procedure, such initiation includes: presetting a constant N equal to a total number of the slave devices; presetting a variable B as zero; and presetting a constant A as an address to be assigned to the device 110 by the master processor 101. In this preferred embodiment, the constant N=3, the constant A=10h. In step S303, the master processor 101 checks if B<N. If B>=N, the procedure ends here. Otherwise, the procedure goes to step S304. At this time, because B=0 and N=3, the procedure goes directly to step S304. In step S304, the master processor 101 sets the variable X=A+B. At this time, A=10h and B=0, so the variable X=10h. In step S305, the master processor 101 generates an instruction of resetting an address of a device, and then sends the instruction to the I²C bus 102. The instruction is to reset a new address with a value of the variable X to the device whose address is the default address S at the time. It should be noted that the variable X=10h and the address of the device 110 is the default address S at the moment. Then, in step S306, the master processor 101 sets B=B+1. That is, after step S306, the value of B is 1, rather than 0 which is set in step S302. In step S307, the master processor 101 of the bus driver 100 waits for another 20 milliseconds. Then, the procedure returns to step S303, and the master processor 101 checks if B<N. Based on the initiation results in step S302, the master processor 101 assigns three different addresses to the device (110, 120, 130) respectively, with the first address being 10h, the second address being 11h, and the last address being 12h.

As a result, after all the procedures end, the device 110 has the address 10h, and the device 120 has the address 11h, and the device 130 has the address 12h.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for dynamically allocating addresses to devices coupled to an integrated circuit bus, the system comprising:
a first slave processor that presets an address of a first device of the devices coupled to the integrated circuit bus to a default address;
a master processor that assigns a first address to the first device whose address is the default address at that time; and
a second slave processor that presets an address of a second device connected to the integrated circuit bus downstream of the first device to the default address after the first address is assigned to the first device, the master processor assigning a second address to the second device whose address is the default address at that time, wherein the second address is different from the first address.

2. The system according to claim 1, wherein the integrated circuit bus is an inter integrated circuit bus.

3. The system according to claim 1, further comprising: the master processor assigning different addresses to others of the devices in sequence.

4. The system according to claim 1, wherein the default address is a predetermined constant address, and is different from any of the addresses assigned by the master processor to all of the devices.

5. The system according to claim 1, further comprising:
an electrical bus for connecting the devices in series, each of the devices including an in port and an out port for the electrical bus, and a Vcc power supply which controls voltages of the in port and out port;
wherein,
the in port of the first device is initialized with a high voltage, in ports of others of the devices are initialized with a low voltage; and the out port of the first device is downstream the electrical bus of the in port of the second device.

6. The system according to claim 5, wherein the first slave processor presets an address of the first device to the default address after the Vcc power supply of the first device sets an voltage of the in port of the first device to a high voltage.

7. The system according to claim 5, further comprising: the Vcc power supply of the first device setting an voltage of the out port of the first device to a high voltage, after the first address is assigned to the first device.

8. A system for dynamically allocating addresses to devices coupled to an integrated circuit bus, the system comprising:
a master processor for:
generating a plurality of addresses one by one which are different from each other; and
sending an instruction to the integrated circuit bus in order to assign one of the plurality of addresses to one of the devices whose address is a default address at that time; and
a plurality of slave processors corresponding to the devices, each of the plurality of slave processors including a plurality of functions of:
presetting an address of a corresponding device of the devices to the default address;
retrieving the instruction; and
resetting the address of the corresponding device of the devices according to the instruction.

9. The system according to claim 8, wherein the integrated circuit bus is an inter integrated circuit bus.

10. The system according to claim 8, further comprising a plurality of power supplies corresponding to the devices, each of the plurality of power supplies controlling a voltage of a corresponding device of the devices, in order that an address can be set to the corresponding device.

11. A method for dynamically allocating addresses to devices coupled to an integrated circuit bus, the method comprising the steps of:
controlling, by a first power supply, a voltage of a first device of the devices coupled to the integrated circuit bus, in order that an address can be set to the first device;
presetting the address of the first device to a default address;
assigning a first address to the first device;
controlling, by a second power supply, a voltage of a second device of the devices coupled to the integrated circuit bus downstream of the first device, in order that an address can be set to the second device;
presetting the address of the second device to the default address; and
assigning a second address to the second device, the second address being different from the first address.

12. The method according to claim 11, wherein the integrated circuit bus is an inter integrated circuit bus.

13. The method according to claim 11, wherein each of the first power supply and the second power supply is a Vcc power supply.

14. The method according to claim 11, further comprising the step of assigning different addresses to others of the devices in sequence.

15. The method according to claim 14, wherein the default address is a predetermined constant address, and is different from any of the addresses assigned to all of the devices.
